(19) United States
(12) Patent Application Publication
(10) Pub. No.: US 2008/0010397 A1
(43) Pub. Date: Jan. 10, 2008

(54) Flash memory with simulating system and method thereof

(75) Inventors: Jen-Chieh Lou, Hsinchu (TW); Chih-Jen Hsu, Hsinchu (TW)

Correspondence Address: YIANNIS NICOLAOS FRAGOS, PO BOX 70249, GLYFADA, ATHENS, 16610, omitted

(73) Assignee: Phison Electronics Corp., Hsinchu (TW)

(21) Appl. No.: 11/482,738

(22) Filed: Jul. 10, 2006

(51) Int. Cl. G06F 12/00

(52) U.S. Cl. 711/103

(57) ABSTRACT

The invention presents a multi-type flash memory with simulating system and a method thereof. Meanwhile the method includes the steps of a) providing a simulating circuit data for the multi-type flash memory; b) transforming the simulating circuit data into a programmable circuit device; c) connecting a flash memory access interface of the multi-type flash memory with a first host system; d) connecting a large-scale access interface of the multi-type flash memory with a second host system; e) transmitting data signals between a buffer register of the multi-type flash memory and the first/second host systems via the flash memory access interface/the large-scale access interface; and f) transmitting control signal between the buffer register and the first/second host systems via the programmable circuit device and the flash memory access interface/the large-scale access interface, thereby incorporating a simulating system into the multi-type flash memory conveniently.

### FIELD OF THE INVENTION

The present invention relates to a simulating system of a memory and a method thereof, and more particularly, to a multi-type flash memory with a simulating system and a method thereof.

### BACKGROUND OF THE INVENTION

Flash memory devices have many advantages for a large number of applications. These advantages include their non-volatility, speed, ease of erasure and reprogramming, small physical size and related factors. There are no mechanical moving parts and as a result such systems are not subject to failures of the type most often encountered with hard disk storage systems. As a result many portable computer devices, such as laptops, portable digital assistants, portable communication devices, and many other related devices are using flash memory as the primary medium for storage of information.

In practice, there are several kinds of flash memory with different specifications. A host system, such as a CPU of computer, should supplies related operating system for deal with different flash memory. A specific example of a CPU is illustrated in FIG. 1 and FIG. 2, wherein they together illustrate a data processing system, which can be used to perform the simulation methods. FIG. 1 and FIG. 2 illustrate a CPU portion 200, which is coupled via a 32-bit address bus 272 and a 64-bit data bus 274 to external memory 280. The CPU 200 has a fetch unit 212. The fetch unit 212 is responsible for fetching computer instructions from the 16 kilobit I (Instruction) cache 254 via the 128 bit bus 258 making use of the instruction memory management unit (IMMU) 250. The fetch unit 212 provides instructions, which fill an eight-instruction queue 214 as illustrated in FIG. 2. The fetch unit 212 continues to fetch as many as four instructions at a time to ensure that the queue 214 is continually filled with instructions, which can be processed by the CPU portion 200.

Furthermore, a branch-processing unit 216, which contains branch prediction information, is used to control the fetcher 212 so that the proper execution flow of instructions is maintained within the instruction queue 214. A dispatch unit 218 is provided to decode the instructions and issue the instructions to an appropriate execution unit as illustrated in a central portion of FIG. 1 and FIG. 2 dispatch unit 218 can provide decoded instructions to one of four types of execution unit illustrated in a middle portion of FIG. 1 and FIG. 2. These four types are the floating-point unit 240, the load/store unit 234, the single cycle integer units 228, and the multiple cycle integer unit 224. The units 218, 216, 214, and 212 are all portions of a larger instruction unit 210, which is responsible for providing a continual stream of instructions to one of the many execution units. A bus interface unit 270 interfaces to the external busses 272 and 274. The bus interface unit 270 places instructions into an I (Instruction) cache 254 associated with instruction tags 252. Data is also read from external memory via the bus interface unit 270 and placed within the D (Data) cache 264. Instructions are also provided via the instruction memory management unit (MMU) 250 to the instruction fetch unit 212. FIG. 3 further illustrates a flow chart of operation used by the above simulator to provide output signal.

Accordingly, the method may be provided to enable integrated circuit simulation via articles of manufacture, which are manufactured to contain the software elements 540 and 544. The software portions stored in memory 280 are typically loaded into memory 280 from computer readable media 286. However, it fails to disclose a method for facilitating to incorporating the simulating system to multi-type flash memories.

However, there are many kinds of flash memories provided for a large number of applications, and large memory space and multi functions are incorporated into flash memories. When a designer of flash memory would like to design the software or hardware for flash memory, several testing modules and simulators should be supplied in response to different flash memories for testing compatibility or adjusting functions. Therefore, in practice, the prior art should waste more time and source and cost a lot for developing the flash memory. On the other hand, it is difficult to implement. Hence, it needs to provide a multi-type flash memory with a simulating system, which provides a specific control circuit for incorporating the specification of flash memory to a programmable device, simplifies the entire structure and the control process thereof, is capable of achieving the purpose of simulating the control interface and functions of different flash memories easily, and can rectify those drawbacks of the prior art and solve the above problems.

### SUMMARY OF THE INVENTION

This paragraph extracts and compiles some features of the present invention; other features will be disclosed in the follow-up paragraph. It is intended to cover various modifications and similar arrangements included within the spirit and scope of the appended claims, and this paragraph also is considered to refer.

Accordingly, the prior art is limited by the above problems. It is an object of the present invention to provide a multi-type flash memory with a simulating system, which provides a specific control circuit for incorporating the specification of flash memory to a programmable device, simplifies the entire structure and the control process thereof, is capable of achieving the purpose of simulating the control interface and functions of different flash memories easily, and can rectify those drawbacks of the prior art and solve the above problems.

In accordance with an aspect of the present invention, the multi-type flash memory with simulating system includes a programmable circuit device; a transforming circuit connected with the programmable circuit device for transforming a specification of the multi-type memory to be stored in the programmable circuit device; a random access memory (RAM) connected with the programmable circuit device; and an access interface connected with the programmable circuit device and the RAM, wherein while a host system is connected with the access interface, a control signal is transmitted to the RAM via the programmable circuit device, and a data signal is transmitted to the RAM directly.

Preferably, the host system is one of a software application and a hardware application.

Preferably, the access interface further includes a flash memory access interface and a large-scale access interface.

Certainly, the host system can be one of a software application and a hardware application and connected with the flash memory access interface.

Certainly, the large-scale access interface can be connected to a computer apparatus.

Preferably, the large-scale access interface is one selected from a group consisting of a USB port, a COM port and a print port.

In accordance with another aspect of the present invention, the multi-type flash memory with simulating system includes a programmable circuit device; a transforming circuit connected with the programmable circuit device for transforming a specification of the multi-type memory to be stored in the programmable circuit device; a random access memory (RAM) connected with the programmable circuit device; a flash memory access interface connected with the programmable circuit device and the RAM, wherein while a first host system is connected with the flash memory access interface, a control signal is transmitted to the RAM via the programmable circuit device, and a data signal is transmitted to the RAM directly; and a large-scale access interface connected with the programmable circuit device and the RAM, wherein while a second host system is connected with the large-scale access interface, a control signal is transmitted to the RAM via the programmable circuit device, and a data signal is transmitted to the RAM directly.

Preferably, the first host system is one of a software application and a hardware application.

Certainly, the second host system can be a computer apparatus.

Preferably, the large-scale access interface is one selected from a group consisting of a USB port, a COM port and a print port.

It is another object of the present invention to provide a method of a multi-type flash memory with a simulating system, which incorporates the simulating system by means of providing a specific control circuit for incorporating the specification of flash memory to a programmable device, simplifies the entire structure and the control process thereof, is capable of achieving the purpose of simulating the control interface and functions of different flash memories easily, and can rectify those drawbacks of the prior art and solve the above problems.

In accordance with the aspect of the present invention, the method of a multi-type flash memory with simulating system includes a) providing a simulating circuit data for the multi-type flash memory; b) transforming the simulating circuit data into a programmable circuit device; c) connecting an access interface of the multi-type flash memory with a host system; and d) transmitting data signals between a RAM of the multi-type flash memory and the host system via the access interface; and transmitting control signal between the RAM and the host system via the programmable circuit device and the access interface, thereby incorporating a simulating system into the multi-type flash memory conveniently.

Preferably, the step b) is executed via a transforming circuit connected with the programmable circuit device.

Preferably, the simulating circuit data is a specification of the multi-type memory.

Certainly, the host system can be one of a software application and a hardware application.

In accordance with another aspect of the present invention, the method of a multi-type flash memory with simulating system includes a) providing a simulating circuit data for the multi-type flash memory; b) transforming the simulating circuit data into a programmable circuit device; c) connecting a flash memory access interface of the multi-type flash memory with a first host system; d) connecting a large-scale access interface of the multi-type flash memory with a second host system; e) transmitting data signals between a buffer register of the multi-type flash memory and the first/second host systems via the flash memory access interface/the large-scale access interface; and transmitting control signal between the buffer register and the first/second host systems via the programmable circuit device and the flash memory access interface/the large-scale access interface, thereby incorporating a simulating system into the multi-type flash memory conveniently.

Preferably, the first host system is one of a software application and a hardware application.

Preferably, the second host system is a computer apparatus.

Preferably, the step b) is executed via a transforming circuit connected with the programmable circuit device.

Preferably, the simulating circuit data is a specification of the multi-type memory.

Preferably, the buffer register is a random access memory (RAM) connected with the programmable circuit device.

Preferably, the large-scale access interface is one selected from a group consisting of a USB port, a COM port and a print port.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 and FIG. 2 together are a block diagram illustrating one specific example of a data processing system according to the prior art;

FIG. 3 illustrates a flow chart of the method of operation used by simulator to provide the output signal according to the prior art;

FIG. 4 illustrates a preferred embodiment of a multi-type flash memory with simulating system according to the present invention.

FIG. 5 illustrates a method of a multi-type flash memory with simulating system according to the present invention.

FIG. 6 illustrates another preferred embodiment of a multi-type flash memory with simulating system according to the present invention.

FIG. 7 illustrates another method of a multi-type flash memory with simulating system according to the present invention.

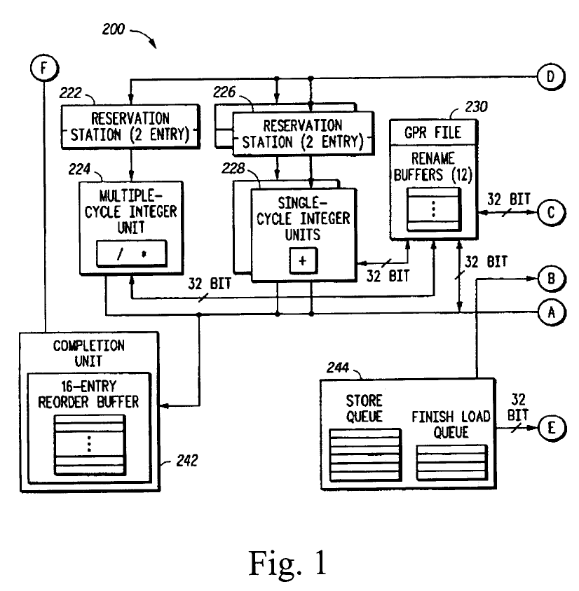

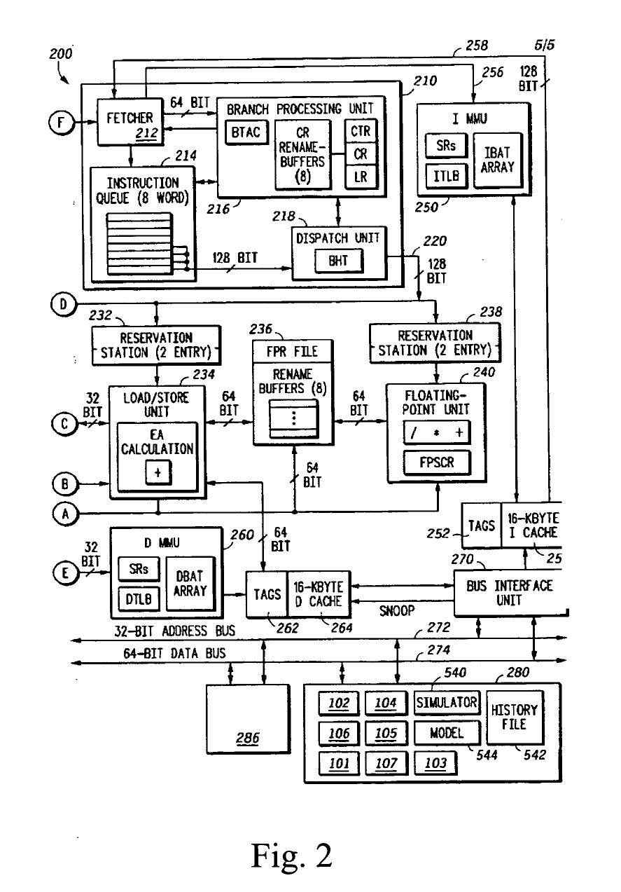

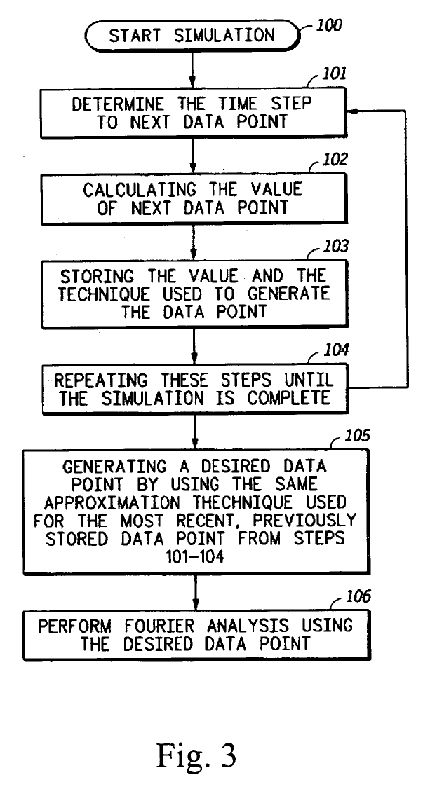

### DETAILED DESCRIPTION OF THE PREFERRED EMBODIMENT

The present invention discloses a multi-type flash memory with a simulating system and a method thereof, and the objects and advantages of the present invention will become more readily apparent to those ordinarily skilled in the art after reviewing the following detailed description. The present invention needs not be limited to the following embodiment.

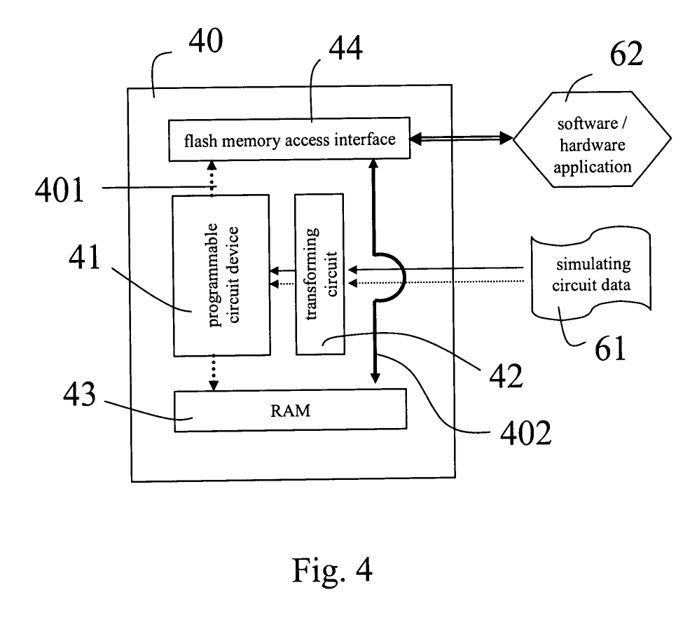

Please refer to FIG. 4. It illustrates a preferred embodiment of a multi-type flash memory with simulating system according to the present invention. As shown in FIG. 4, the multi-type flash memory with simulating system includes a programmable circuit device 41; a transforming circuit 42 connected with the programmable circuit device 41 for transforming a simulating circuit data 61, which is a specification of the multi-type memory 40, to be stored in the programmable circuit device 41; a random access memory (RAM) 43 connected with the programmable circuit device 41; and an access interface 44 connected with the programmable circuit device 41 and the RAM 43, wherein while a host system 62 is connected with the access interface 44, control signals 401 is transmitted to the RAM 43 via the programmable circuit device 41; and data signals 402 is transmitted to the RAM 43 directly.

In practice, the host system 62 can be a software application or a hardware application; and the access interface 44 can be a flash memory access interface. For achieving the purpose of simulating the control interface and functions of different flash memories easily, the present invention further discloses a method of a multi-type flash memory with simulating system.

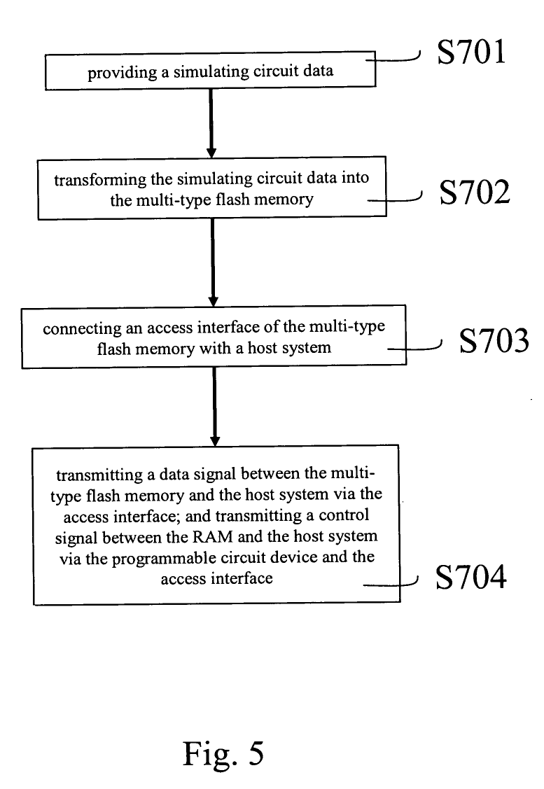

Please refer to FIG. 5. It illustrates a method of a multi-type flash memory with simulating system according to the present invention. As shown in FIG. 5, the method includes the steps of a) providing a simulating circuit data (as shown in FIG. 4, 61) for the multi-type flash memory (as shown in FIG. 4, 40), as the procedure S701 of FIG. 5; b) transforming the simulating circuit data into a programmable circuit device (as shown in FIG. 4, 41), as the procedure S702 of FIG. 5; c) connecting an access interface (as shown in FIG. 4, 44) of the multi-type flash memory with a host system (as shown in FIG. 4, 62), as the procedure S703 of FIG. 5; and d) transmitting data signals (as shown in FIG. 4, 402) between a RAM (as shown in FIG. 4, 43)of the multi-type flash memory and the host system via the access interface; and transmitting control signal (as shown in FIG. 4, 401) between the RAM and the host system via the programmable circuit device and the access interface, as the procedure S704 of FIG. 5, thereby incorporating a simulating system into the multi-type flash memory conveniently. Thus, testing modules and simulators could be easily incorporated into any multi-type flash memory according to the present invention. When a designer of flash memory would like to design the software or hardware for flash memory, he won't need waste a lot time to deal with the simulating system of a flash memory.

In practice, the step b) is executed via a transforming circuit (as shown in FIG. 4, 42) connected with the programmable circuit device. Similarly, the simulating circuit data is a specification of the multi-type memory; and the host system can be a software application or a hardware application.

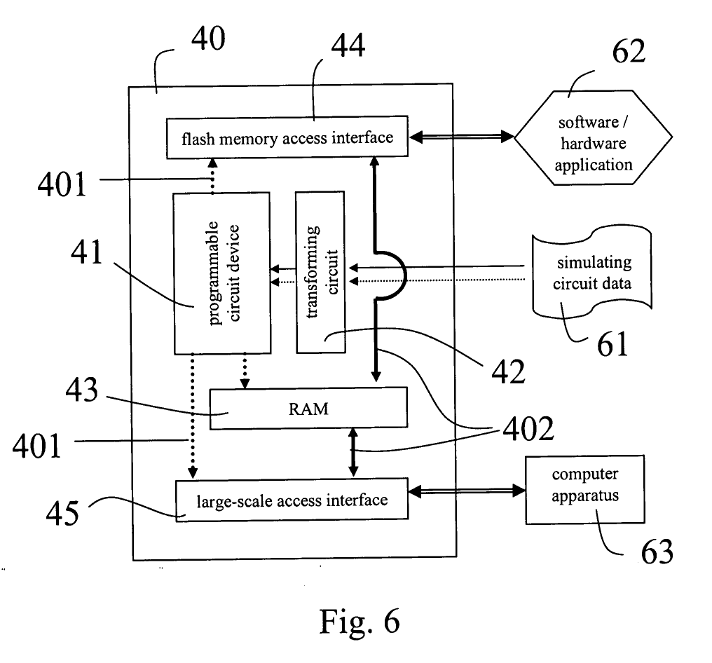

In accordance with another aspect, the present invention further discloses a multi-type flash memory with simulating system 40, as shown in FIG. 6, including a programmable circuit device 41; a transforming circuit 42 connected with the programmable circuit device 41 for transforming a simulating circuit data 61, which is a specification of the multi-type memory to be stored in the programmable circuit device 41; a random access memory (RAM) 43 connected with the programmable circuit device 41; a flash memory access interface 44 connected with the programmable circuit device 41 and the RAM 43, wherein while a first host system 62 is connected with the flash memory access interface 44, control signals 401 is able to be transmitted to the RAM 43 via the programmable circuit device 41; and data signals 402 is transmitted to the RAM 43 directly; and a large-scale access interface 45 connected with the programmable circuit device 41 and the RAM 43, wherein while a second host system 63 is connected with the large-scale access interface 45, control signals 401 is transmitted to the RAM 43 via the programmable circuit device 41; and data signals 402 is transmitted to the RAM 43 directly.

In practice, the first host system 62 can be a software application or a hardware application; and the second host system 63 can be a computer apparatus. Furthermore, the large-scale access interface 45 can be a USB port, a COM port or a print port.

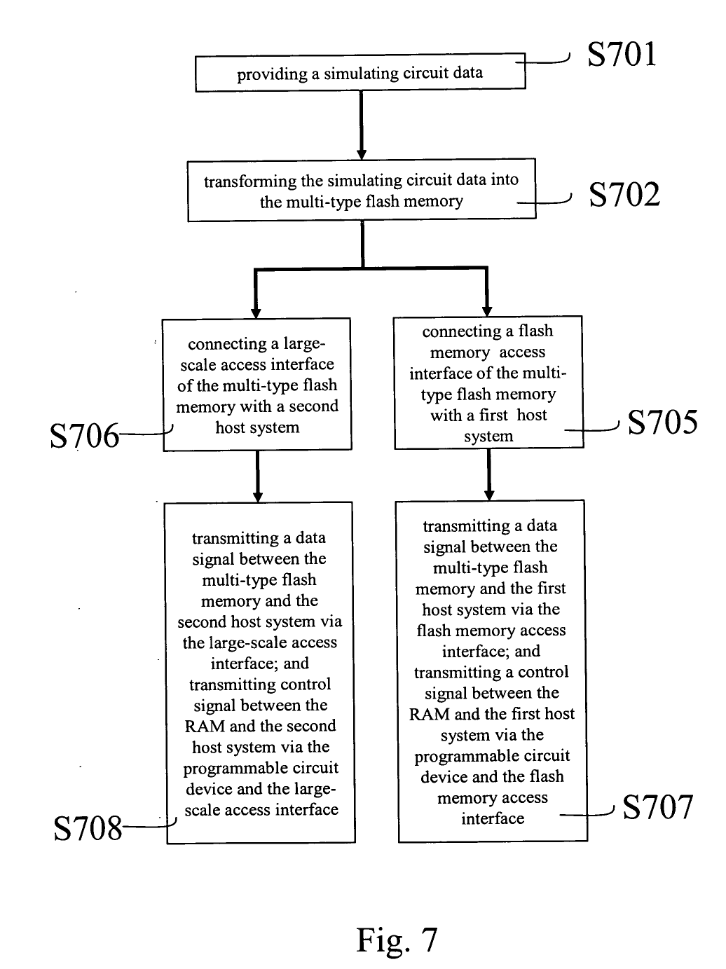

Certainly, the present invention further discloses a method of a multi-type flash memory with simulating system corresponding to the embodiment of FIG. 6 for achieving the purpose of simulating the control interface and functions of different flash memories easily. Please refer to FIG. 7 and FIG. 6. The method of a multi-type flash memory with simulation system includes the steps of a) providing a simulating circuit data 61 for the multi-type flash memory 40, as the procedure S701 of FIG. 7; b) transforming the simulating circuit data 61 into a programmable circuit device 41, as the procedure S702 of FIG. 7; c) connecting a flash memory access interface 44 of the multi-type flash memory with a first host system 62, as the procedure S705 of FIG. 7; d) connecting a large-scale access interface 45 of the multi-type flash memory with a second host system 63, as the procedure S706 of FIG. 7; e) transmitting data signals 402 between a buffer register 43 of the multi-type flash memory and the first/second host systems via the flash memory access interface 44/the large-scale access interface 45; and f) transmitting control signal between the buffer register 43 and the first/second host systems via the programmable circuit device 41 and the flash memory access interface 44/the large-scale access interface 45, as the procedures S707 and S708 of FIG. 7, thereby incorporating a simulating system into the multi-type flash memory conveniently.

In practice, the first host system 62 can be a software application or a hardware application; and the second host system 63 is a computer apparatus. Furthermore, the step b) is executed via a transforming circuit 42 connected with the programmable circuit device 41. Certainly, the buffer register 43 is a random access memory (RAM) connected with the programmable circuit device 43. The large-scale access interface 45 can be a USB port, a COM port or a print port.

In conclusion, the present invention provides provide a multi-type flash memory with a simulating system, which provides a specific control circuit for incorporating the specification of flash memory to a programmable device, simplifies the entire structure and the control process thereof, is capable of achieving the purpose of simulating the control interface and functions of different flash memories easily, and can rectify those drawbacks of the prior art and solve the above problems. Meanwhile, testing modules and simulators could be easily incorporated into any multi-type flash memory according to the present invention. The flash memory applied in the present invention could supply a large memory space for data storage while the flash memory is connected to a software or a hardware application. Furthermore, the flash memory of the present invention could supply RAM as a buffer register while the flash memory further connects with a computer via the large-scale access interface. User could review or adjust functions via application of computer for facilitating to develop multi-type flash memories. Meanwhile the prior art fail to disclose that. Accordingly, the present invention possesses many outstanding characteristics, effectively improves upon the drawbacks associated with the prior art in practice and application, produces practical and reliable products, bears novelty, and adds to economical utility value. Therefore, the present invention exhibits a great industrial value.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A multi-type flash memory with simulating system comprising:
a programmable circuit device;
a transforming circuit connected with said programmable circuit device for transforming a specification of said multi-type memory to be stored in said programmable circuit device;
a random access memory (RAM) connected with said programmable circuit device; and
an access interface connected with said programmable circuit device and said RAM, wherein while a host system is connected with said access interface, a control signal is transmitted to said RAM via said programmable circuit device, and a data signal is transmitted to said RAM directly.

2. The multi-type flash memory with simulating system according to claim l, wherein said host system is one of a software application and a hardware application.

3. The multi-type flash memory with simulating system according to claim 1, wherein said access interface further comprises a flash memory access interface and a large-scale access interface.

4. The multi-type flash memory with simulating system according to claim 3, wherein said host system is one of a software application and a hardware-application and connected with said flash memory access interface.

5. The multi-type flash memory with simulating system according to claim 3, wherein said large-scale access interface is connected to a computer apparatus.

6. The multi-type flash memory with simulating system according to claim 3, wherein said large-scale access interface is one selected from a group consisting of a USB port, a COM port and a print port.

7. A multi-type flash memory with simulating system comprising:
a programmable circuit device;
a transforming circuit connected with said programmable circuit device for transforming a specification of said multi-type memory to be stored in said programmable circuit device;
a random access memory (RAM) connected with said programmable circuit device;
a flash memory access interface connected with said programmable circuit device and said RAM, wherein while a first host system is connected with said flash memory access interface, a control signal is transmitted to said RAM via said programmable circuit device, and a data signal is transmitted to said RAM directly; and
a large-scale access interface connected with said programmable circuit device and said RAM, wherein while a second host system is connected with said large-scale access interface, a control signal is transmitted to said RAM via said programmable circuit device, and a data signal is transmitted to said RAM directly.

8. The multi-type flash memory with simulating system according to claim 7, wherein said first host system is one of a software application and a hardware application.

9. The multi-type flash memory with simulating system according to claim 7, wherein said second host system is a computer apparatus.

10. The multi-type flash memory with simulating system according to claim 7, wherein said large-scale access interface is one selected from a group consisting of a USB port, a COM port and a print port.

11. A method of a multi-type flash memory with simulating system comprising the steps of:
a) providing a simulating circuit data for said multi-type flash memory;
b) transforming said simulating circuit data into a programmable circuit device;
c) connecting an access interface of said multi-type flash memory with a host system; and
d) transmitting data signals between a RAM of said multi-type flash memory and said host system via said access interface, and transmitting control signal between said RAM and said host system via said programmable circuit device and said access interface, thereby incorporating a simulating system into said multi-type flash memory conveniently.

12. The method according to claim 11, wherein said step b) is executed via a transforming circuit connected with said programmable circuit device.

13. The method according to claim 11, wherein said simulating circuit data is a specification of said multi-type memory.

14. The method according to claim 11, wherein said host system is one of a software application and a hardware application.

15. A method of a multi-type flash memory with simulating system comprising the steps of:
a) providing a simulating circuit data for said multi-type flash memory;
b) transforming said simulating circuit data into a programmable circuit device;
c) connecting a flash memory access interface of said multi-type flash memory with a first host system;
d) connecting a large-scale access interface of said multi-type flash memory with a second host system;
e) transmitting data signals between a buffer register of said multi-type flash memory and said first/second host systems via said flash memory access interface/said large-scale access interface; and
f) transmitting control signal between said buffer register and said first/second host systems via said programmable circuit device and said flash memory access interface/said large-scale access interface, thereby incorporating a simulating system into said multi-type flash memory conveniently.

16. The method according to claim 15, wherein said first host system is one of a software application and a hardware application.

17. The method according to claim 15, wherein said second host system is a computer apparatus.

18. The method according to claim 15, wherein said step b) is executed via a transforming circuit connected with said programmable circuit device.

19. The method according to claim 15, wherein said simulating circuit data is a specification of said multi-type memory.

20. The method according to claim 15, wherein said buffer register is a random access memory (RAM) connected with said programmable circuit device.

21. The method according to claim 15, wherein said large-scale access interface is one selected from a group consisting of a USB port, a COM port and a print port.
